(19) United States
(12) Patent Application Publication
(10) Pub. No.: US 2006/0115789 A1
(43) Pub. Date: Jun. 1, 2006

(54) Self-approximating intraoral

(76) Inventor: Kenneth Donovan Wishart, Livermore, CA (US)

Correspondence Address: Kenneth D. Wishart, 363 Sea Wolf Way, Livermore, CA, 94550, US

(21) Appl. No.: 10/997,635

(22) Filed: Nov. 26, 2004

(51) Int. Cl. A61C 5/14

(52) U.S. Cl. 433/136

(57) ABSTRACT

A self-approximating intraoral isolation device to be used during dental procedures requiring a dry field of operation. The inventive device includes a fluid-resistant shell comprising a receptacle portion and an extruded region that receives the teeth through an opening in a sealing portion. Upon application of the forces of the opposing arches of the jaws, the extruded portion of the shell brings into closer approximation the sealing region of the device, improving upon previously described devices.

### CROSS-REFERENCE TO RELATED APPLICATIONS

U.S. Patent Documents

| | | | |
|---|---|---|---|
| 692,281 | February, 1902 | Hare | 433/93 |
| 770,854 | September, 1904 | Hare | 433/93 |
| 2,092,549 | September, 1937 | Craigo | 32/34 |
| 2,637,107 | May, 1952 | Daigle | 433/136 |
| 4,992,046 | February, 1991 | Sharp | 433/93 |
| 5,340,313 | August, 1994 | Hussin | 433/140 |
| 5,152,686 | October, 1992 | Duggan, et al | 433/140 |

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates generally to the field of dentistry and more specifically it relates to the isolation of teeth from intraoral structures and fluids.

2. Description of the Related Art

In the field of dentistry there has been an ongoing search for a simple means of isolating the tooth or teeth to be worked on from the surrounding oral environment, an environment that, by its very nature, makes the delivery of care very difficult. Achieving adequate isolation accomplishes, at a minimum, the following: it enhances the employment of restorative materials and procedures that are best used in a moisture-free or biofilm-free environment; it protects the patient from noxious chemicals, sharp objects, and the aspiration of by-products of our work; it reduces the aerosolization of the patient's biofluids which are potentially infectious to dental personnel.

Such isolation can be accomplished by use of a rubber dam, an appliance suggested in 1864 by Sanford C. Barnum. Various modifications have been made to this device, but comfort and ease of application are not among its strong points. It is well known in the field that local anesthesia is typically required to apply the rubber dam, and a considerable amount of time and operator skill are necessary as well. The fact that recent treatment modalities such as laser and air-abrasion cavity preparation often require no anesthesia makes use of the traditional rubber dam problematic.

To improve upon the rubber dam various retractors and cup-shaped receptacles have been devised, all intended to receive within their confines the teeth to be worked on while sealing the area from the surrounding oral tissues and fluids:

U.S. Pat. No. 692,281, issued to W. Hare in 1902, described a retractor and mouth prop to aid in isolation. A refinement by Hare two years later with U.S. Pat. No. 770,854 suggested a mouth prop and cheek distender that received teeth into a receptacle.

U.S. Pat. No. 2,092,549, issued to John M. Craigo, described a cup receptacle that isolated the field of operation of one or several teeth.

U.S. Pat. No. 2,637,107, issued to B. J. Daigle, described a dental isolation tray wherein a flexible chamber received the teeth to be operated upon.

U.S. Pat. No. 4,992,046, issued to Harry K. Sharp, described a hollow mouth prop that received the teeth to be operated upon.

U.S. Pat. No. 5,340,313, issued to Gregory J. Hussin, described a cup-shaped device that received the teeth into its interior to be operated upon, with an adhesive membrane to be adapted against the gum tissue.

Each of these has attempted to supply a replacement for the rubber dam, but none has simply, economically, comfortably, and effectively accomplished all of the objectives as one would desire from such an article. The main problem with each of the above devices is inadequate sealing, which of course if the main objective of such an item and the one that the rubber dam addresses so well despite its stated drawbacks.

Acknowledging the prior art, the self-approximating intraoral isolation device according to the present invention improves upon it to provide rapid, comfortable, inexpensive, but most critically effective intraoral isolation for the dental practitioner.

This application references a previously submitted provisional patent application regarding the present invention.

### BRIEF SUMMARY OF THE INVENTION

In light of the above discussion the general purpose of the present invention, which will be described subsequently in greater detail, is to provide an intraoral isolation device wherein a dental practitioner might quickly and easily isolate an area of a patient's mouth for carrying out any number of procedures.

To accomplish this, the present invention generally comprises
a receptacle for carrying out operations within the mouth, said receptacle being fabricated of a flexible material generally perceived as being comfortable by the recipient patient and specifically conformable to irregular oral anatomies such that its close adherence and adaptation will prevent the ingress of fluids to the interior of said receptacle;
said receptacle being of inexpensive fabrication such that it might be disposed of after use to address infection-control criteria;
an opening in said receptacle through which one or more teeth may be received;
reinforcement of said receptacle, to be either incorporated into the structure of the receptacle by means of relieves or ridges or additional thickness of the flexible material, or fabricated separately from said receptacle and fastened to it, or provided by allowing sufficient thickness or strength of the receptacle material in areas critical to performing its sealing function;
said reinforcement acting to prop the mouth open during any operations performed;
said reinforcement acting to retract the lips, cheeks, tongue, and other impinging oral tissues away from the operative field;
said reinforcement acting, by its design, to bring the flexible material forcibly into closer approximation to the oral tissues to improve the fluid barrier effect when the recipient patient's jaws or teeth are closed upon the device, this being an improvement to prior art that makes the device more functional in its intended purpose.

There has thus been outlined, in a general sense, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the invention is to provide a self-approximating intraoral isolation device that will overcome the shortcomings of prior art devices.

An object of the present invention is to provide a self-approximating intraoral isolation device at least some of whose principle components are disposable.

Another object is to provide a self-approximating intraoral isolation device that will satisfy the infection control criteria inherent to dental procedures in general.

Another object is to provide a self-approximating intraoral isolation device that is relatively comfortable to the patient.

Another object is to provide a self-approximating intraoral isolation device that is inexpensive enough in its manufacture that disposability will be feasible.

Other objects and advantages of the present invention will become obvious to the reader and it is intended that these objects and advantages be within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of one embodiment of the present invention.

FIG. 2 is an exploded view of the invention of FIG. 1 showing all of the components.

FIG. 3 is a representation of the invention of FIG. 1 in use.

FIG. 4 depicts the direction of forces encountered during use of the invention of FIG. 1, said forces causing the sealing region to approximate toward the oral tissues.

### DETAILED DESCRIPTION OF THE INVENTION

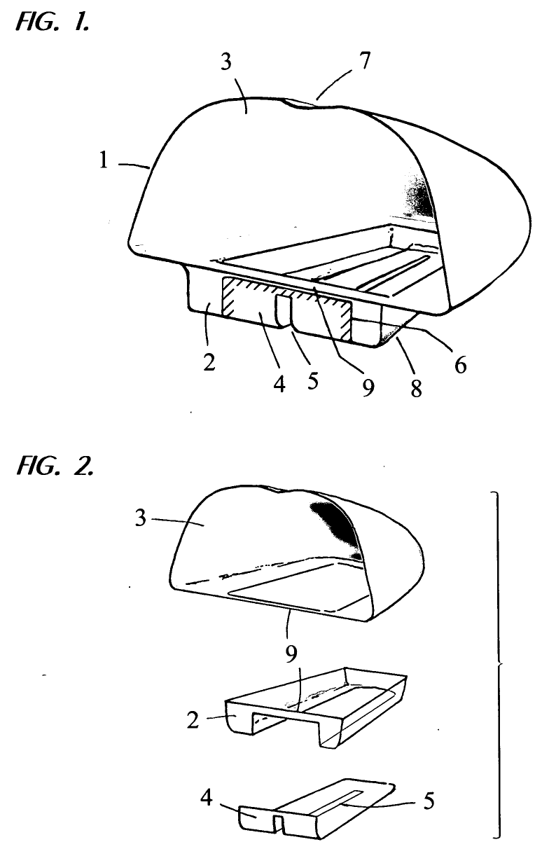

Turning now descriptively to the drawings, in which similar reference characters denote similar elements throughout the several views, the attached figures illustrate a self-approximating intraoral isolation device. Referring to FIG. 1, an outer shell (1) of a fluid-resistant, flexible material, in the preferred embodiment a thermoformable plastic, establishes an extruded region (2) which receives the teeth to be isolated and a receptacle region (3) which distends or retracts the soft oral tissues from the field of operation. The teeth penetrate into the extrusion region through a flexible region (4), in the preferred embodiment a soft polymer sheet, via an opening (5) that has been created upon fabrication. Said opening could also be made by the operator to customize the device in another embodiment. Said polymer sheet (4) in the preferred embodiment is adhesively fastened to the outer shell in the region denoted (6), although other means of integrating these members are possible, inclusive of but not limited to unitary fabrication. The teeth of the opposing arch are received into the slight depression (7), with the dual result being that the mouth is propped open comfortably and that forces are directed in a manner desired for approximation of the opposing lateral walls (8) of region (2). The region designated (9) is an extension of the outer shell material that, because of its thinness relative to the shell material of the receptacle portion, preferentially allows deflection here, said deflection being crucial to the function of the invention.

Referring to FIG. 2, the extruded region (2) and the receptacle region (3) are represented individually, although in the preferred embodiment they are fabricated as a single unit (1). This conceptual separation will be useful in ensuing descriptions of the action of the device in use. The polymer sheet (4) containing the opening (5) is represented separately from the other regions prior to being adhesively fixed to the shell as described previously. The narrow, deflecting extension of shell material (9) is indicated on both regions of the shell, as it would actually be a unitary feature.

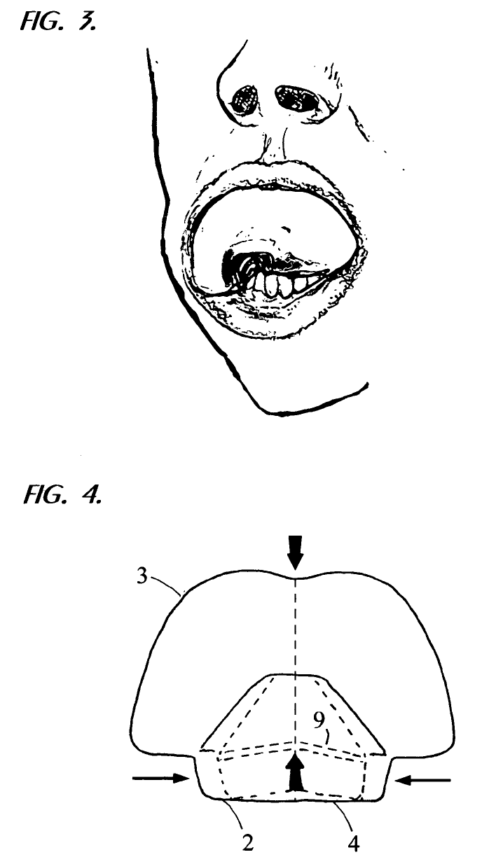

FIG. 3 represents the device in a patient's mouth. It should be noted that the device may be applied to upper or lower posterior teeth, on either side of the mouth.

FIG. 4 shows the unique action of the device that results when forces are applied by the opposing arches of the dentition, said forces represented by the two bold arrows and proceeding generally along the midline. Because of the essential division of the device into an extruded region (2) with a weak leading edge (9), and a more substantial receptacle region (3) as described previously, the forces delivered from the receptacle portion (3) cause the walls of the extruded portion (2) to collapse inward upon themselves as indicated by the thin arrows, as the thin extension (9) yields preferentially to the applied forces and deflects generally as indicated by the broken lines, thereby approximating the polymer sheet (4) toward the oral tissues and improving upon the seal formed. This self-approximation of the sealing region of the invention is somewhat unexpected, but may be verified by constructing the device as described, and may be appreciated by those skilled in the art as an improvement to previous devices.

What I claim is:

1. An intraoral isolation device especially suited for use in the posterior regions of the mouth, comprising:
a rigid receptacle portion, capable of comfortably distending the oral tissues in its majority, and receiving through an aperture one or more posterior teeth or the posterior extension of an edentulous ridge, said aperture approaching the general opening of said receptacle portion so as to leave a connecting anterior edge capable of deflecting to applied forces more readily than the remainder of said receptacle portion; and
a sealing portion generally between said receptacle portion and the gingival tissue adjacent to said teeth or edentulous ridge, containing within its surface an opening formed either upon fabrication or by design of the operator, said sealing portion being forcibly directed toward said gingival tissue as the edges of said aperture approximate toward each other upon closing of the mandible toward the maxillary arch.

2. The device recited in claim 1 wherein said sealing portion is of separate fabrication from that of said receptacle portion, the two portions being adhesively attached to one another;

3. The device recited in claim 1 wherein said sealing portion and said receptacle portion are of unitary fabrication by an overlay injection molding process;

4. The device recited in claim 1 wherein said sealing portion and said receptacle portion are of unitary fabrication, yet achieve the desired differential properties by means of structural reinforcements or relieves or a combination of these;

5. The device described by claim 1, wherein said sealing portion is also absorptive;

6. The device described by claim 1, wherein the receptacle portion contains a concavity opposite said aperture to generally receive the teeth, tooth, or edentulous ridge opposite the working area;

7. The device described by claim 1, wherein the receptacle portion contains means for evacuation of fluids from the oral cavity.
